(19) United States
(12) Patent Application Publication
(10) Pub. No.: US 2026/0061802 A1
(43) Pub. Date: Mar. 5, 2026

(54) FAN CONTROL DEVICE AND FAN CONTROL METHOD

(71) Applicant: Panasonic Automotive Systems Co., Ltd., Kanagawa (JP)

(72) Inventors: Hiroshi TAKICHI, Kanagawa (JP); Yusuke KAZU, Kanagawa (JP)

(73) Assignee: Panasonic Automotive Systems Co., Ltd., Kanagawa (JP)

(21) Appl. No.: 19/303,002

(22) Filed: Aug. 18, 2025

(30) Foreign Application Priority Data
Sep. 4, 2024 (JP) 2024-152178

(51) Int. Cl. B60H 1/00; F04D 27/00

(52) U.S. Cl. CPC B60H 1/00757; B60H 1/00828; F04D 27/004

(57) ABSTRACT

A fan control device that controls a fan used for cooling a cooling target in a vehicle includes a processor. The processor acquires an environmental sound in the vehicle collected by a microphone provided in the vehicle, derives first analysis data by executing frequency analysis on the acquired environmental sound, acquires second analysis data obtained by executing frequency analysis on a fan sound that varies depending on a rotation speed of the fan and that is a sound generated during rotation of the fan, and determines an upper limit of the rotation speed of the fan based on the first analysis data and the second analysis data such that a first index of the environmental sound satisfies a predetermined first condition, the first index being an index related to audibility.

### CROSS-REFERENCE TO RELATED APPLICATIONS

This application is based on and claims priority under 35 USC 119 from Japanese Patent Application No. 2024-152178 filed on Sep. 4, 2024, the contents of which are incorporated herein by reference.

### TECHNICAL FIELD

The present disclosure relates to a fan control device, a fan control method, and a fan control program for controlling a fan.

### BACKGROUND ART

In the related art, an electronic device incorporating a cooling fan is known. An example of the electronic device includes a drive unit that rotationally drives a fan, an analysis unit that analyzes the frequency having a high sound level in the vehicle interior space, a calculation unit that calculates the frequency of strong noise generated by the rotating fan, and a setting unit that sets the rotation speed of the fan based on the frequency of the strong noise calculated by the calculation unit. The drive unit drives the fan at the rotation speed set by the setting unit (see Patent Literature 1).

### CITATION LIST

### Patent Literature

Patent Literature 1: JP2018-176833A

### SUMMARY OF INVENTION

Patent Literature 1 does not consider the human hearing sense. Therefore, it is not considered to control the rotation speed of the fan such that a person present in the vehicle is less likely to perceive the noise as auditory noise.

The present disclosure provides a fan control device, a fan control method, and a computer readable storage medium on a fan control program capable of controlling the rotation speed of a fan is stored such that a person present in a vehicle is less likely to perceive the noise as auditory noise.

The fan control device according to the present disclosure controls a fan used for cooling a cooling target in a vehicle. The fan control device includes a memory storing instructions; and a processor that implements the instructions to acquire an environmental sound in the vehicle collected by a microphone provided in the vehicle; derive first analysis data by executing frequency analysis on the acquired environmental sound; acquire second analysis data obtained by executing frequency analysis on a fan sound that varies depending on a rotation speed of the fan and that is a sound generated during rotation of the fan; and determine an upper limit of the rotation speed of the fan based on the first analysis data and the second analysis data such that a first index of the environmental sound satisfies a predetermined first condition, the first index being an index related to audibility.

The fan control method according to the present disclosure controls a fan used for cooling a cooling target in a vehicle. The fan control method includes acquiring an environmental sound in the vehicle collected by a microphone provided in the vehicle; deriving first analysis data by executing frequency analysis on the acquired environmental sound; acquiring second analysis data obtained by executing frequency analysis on a fan sound that varies depending on a rotation speed of the fan and that is a sound generated during rotation of the fan; and determining an upper limit of the rotation speed of the fan based on the first analysis data and the second analysis data such that a first index of the environmental sound satisfies a predetermined first condition, the first index being an index related to audibility.

On the computer readable storage medium according to the present disclosure, a fan control program for causing a computer to execute the above fan control method is stored.

According to the present disclosure, the rotation speed of the fan can be controlled so that a person present in a vehicle is less likely to perceive the noise as auditory noise.

### BRIEF DESCRIPTION OF DRAWINGS

FIG. 1 is a block diagram showing an example of a fan control system according to the present embodiment;

FIG. 2 is a diagram showing an example of an equal loudness level curve according to the present embodiment;

FIG. 3 is a diagram showing an example of the relationship among the rotation speed of a fan, the frequency of the fan sound, and the generated noise according to the present embodiment;

FIG. 4 is a diagram showing simultaneous masking according to the present embodiment;

FIG. 5 is a diagram showing temporal masking according to the present embodiment;

FIG. 6A is a flowchart (part 1) showing an operation example of a fan control device according to the present embodiment; and

FIG. 6B is a flowchart (part 2) showing an operation example of the fan control device according to the present embodiment.

### DESCRIPTION OF EMBODIMENTS

Hereinafter, an embodiment in which a fan control device, a fan control method, and a fan control program according to the present disclosure are specifically disclosed will be described in detail with reference to the drawings as appropriate. However, the unnecessarily detailed description may be omitted. For example, the detailed description of well-known matters and the redundant description of substantially the same configuration may be omitted. This is to avoid unnecessary redundancy of the following description and to facilitate understanding of a person skilled in the art. It should be noted that the accompanying drawings and the following description are provided for a person skilled in the art to fully understand the present disclosure, and are not intended to limit the subject matter described in the claims.

### (Findings as Basis of Present Disclosure)

In Patent Literature 1, the rotation speed of the fan is determined in consideration of only the frequency of strong noise generated by the fan and the sound level of environmental sound. However, no consideration is given to whether a person actually present in the vehicle perceives the noise generated by the fan as auditory noise. The noise includes various frequency components. The sound pressure level of the frequency components of the sound does not coincide with the loudness of the auditory sound of the frequency components. That is, even when the sound pressure level is high, a human does not necessarily perceive that the sound is loud. Therefore, the determined rotation speed of the fan may be excessive or insufficient.

In the following embodiment, a fan control device, a fan control method, and a fan control program capable of controlling the rotation speed of a fan such that a person present in a vehicle is less likely to perceive the noise will be described.

### Embodiment

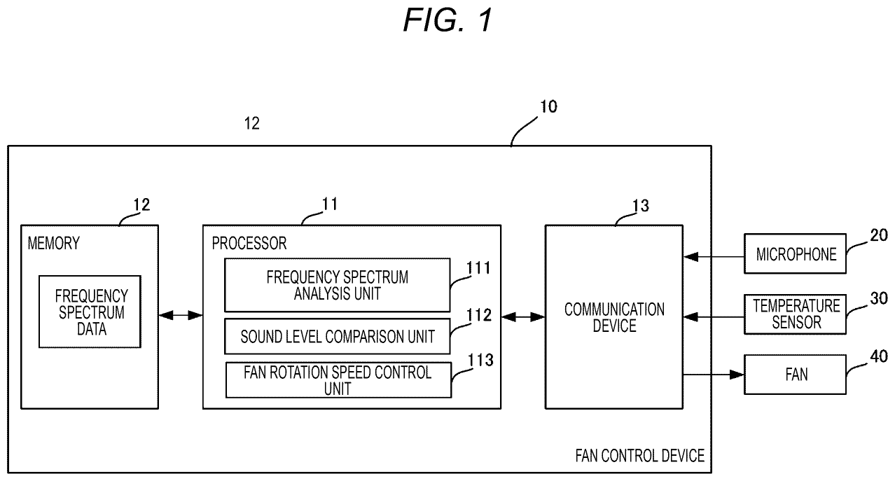

FIG. 1 is a block diagram showing an example of a fan control system according to the present embodiment.

A fan control system 1 includes a fan control device 10, a microphone 20, a temperature sensor 30, and a fan 40. The fan control device 10, the microphone 20, the temperature sensor 30, and the fan 40 can communicate with one another via a network. The network here may be, for example, any one of a wired network, a wireless network, or a combination of a wired network and a wireless network. The wired network corresponds to at least one of, for example, a wired LAN, a wired WAN, and power line communication, and may be other network configurations capable of wired communication. LAN is an abbreviation for Local Area Network. WAN is an abbreviation for Wide Area Network. The power line communication is also described as PLC. PLC is an abbreviation for Power Line Communication. The wireless network corresponds to at least one of a wireless LAN such as Wi-Fi (registered trademark), a wireless WAN, and a mobile communication network such as 4G or 5G, and may have another network configuration capable of wireless communication. The control of the fan 40 by the fan control device 10 may be executed by changing the supply voltage or PWM control.

The fan control device 10 includes a processor 11, a memory 12, and a communication device 13.

The processor 11 includes a frequency spectrum analysis unit 111, a sound level comparison unit 112, and a fan rotation speed control unit 113. The processor 11 is implemented using a CPU, a DSP, an FPGA, or the like. CPU is an abbreviation for Central Processing Unit. The DSP is a digital signal processor. FPGA is an abbreviation for Field Programmable Gate Array. The processor 11 may not include the frequency spectrum analysis unit 111, the sound level comparison unit 112, and the fan rotation speed control unit 113. For example, the functions of the frequency spectrum analysis unit 111, the sound level comparison unit 112, and the fan rotation speed control unit 113 may be executed by the processor 11 executing a fan control program stored in the memory 12.

The frequency spectrum analysis unit 111 acquires data of environmental sound in the vehicle collected using the microphone 20 provided in the vehicle. The frequency spectrum analysis unit 111 executes frequency analysis on the environmental sound data. Specifically, the frequency spectrum analysis unit 111 analyzes the sound pressure level for each frequency of the environmental sound data, and derives analysis data as frequency spectrum data. The environmental sound includes, for example, traveling noise of the vehicle, wind sound generated by the air conditioner of the vehicle, and music reproduced and output as sound. The frequency spectrum data related to the collected environmental sound is also referred to as environmental sound analysis data.

The sound level comparison unit 112 acquires frequency spectrum data for each rotation speed of the sound generated when the fan 40 rotates, which is recorded and stored in the memory 12. The sound generated when the fan 40 rotates is also referred to as fan sound. The frequency spectrum data is data indicating a sound pressure level for each frequency. The frequency spectrum data is, for example, data obtained by executing frequency analysis on sound recorded in advance by the microphone 20 in a vehicle environment similar to that of a vehicle on which a cooling target is mounted. The vehicle at the time of recording is placed in a quiet sound environment, for example, and only fan sound is recorded as much as possible. The frequency spectrum data related to the fan sound held in the memory 12 is also referred to as fan sound analysis data. The sound level comparison unit 112 compares the fan sound analysis data with the environmental sound analysis data. The frequency analysis of the fan sound analysis data may be executed by the processor 11, or may be executed by another device and acquired.

The fan rotation speed control unit 113 determines the upper limit of the rotation speed of the fan 40 based on the fan sound analysis data and the environmental sound analysis data such that a first index related to the audibility of the fan sound satisfies a predetermined first condition. In other words, the fan rotation speed control unit 113 determines the upper limit of the rotation speed of the fan 40 within a range that does not affect the audibility based on the comparison result obtained by the sound level comparison unit 112 comparing the fan sound analysis data with the environmental sound analysis data. The fan rotation speed control unit 113 controls the rotation speed of the fan 40 to be equal to or lower than the determined upper limit. For example, the fan rotation speed control unit 113 controls the rotation speed with the upper limit of the rotation speed of the fan 40 as the target rotation speed, so that the cooling performance of the fan 40 can be improved while preventing the fan sound from being perceived as harsh.

The range that affects the audibility is a range of sound pressure in which a person perceives that the sound is auditorily loud. The range that does not affect the audibility is a range of sound pressure in which a person does not perceive that the sound is auditorily loud. The range that affects the audibility can be defined by an index related to the audibility. For example, the range that affects the audibility is a range of the sound pressure level larger than the audibility threshold value. For example, the range that does not affect the audibility is a range of the sound pressure level equal to or less than the audibility threshold value. The audibility threshold value is a threshold value related to the audibility, and may be, for example, 40 phon, or may be any value of 20 phon to 40 phon, for example, 30 phon.

The fan rotation speed control unit 113 may acquire information on the temperature of a cooling target measured by the temperature sensor 30. The fan rotation speed control unit 113 may determine the upper limit of the rotation speed of the fan 40 based on the temperature of the cooling target. For example, the fan rotation speed control unit 113 may change the upper limit of the rotation speed of the fan 40 to a larger value when the temperature of the cooling target is equal to or higher than a predetermined temperature threshold value. When the temperature of the cooling target is less than the temperature threshold value, the upper limit of the rotation speed of the fan 40 may not be changed or may be reduced. Accordingly, the fan control device 10 can increase the upper limit of the fan rotation speed only when the cooling target is at a high temperature, and thus can cool the cooling target to a desired state while reducing the load on the processor 11.

Pieces of processing executed by the processor 11 may be executed by a single processor or may be executed by a plurality of processors in a distributed manner. For example, the processor 11 that executes the processing for achieving the functions of the frequency spectrum analysis unit 111 and the sound level comparison unit 112 and the processor 11 that executes the processing for achieving the function of the fan rotation speed control unit 113 may be different processors.

The memory 12 includes a ROM and a RAM. ROM is an abbreviation for Read Only Memory. RAM is an abbreviation for Random Access Memory. The ROM stores a program that defines the processing (or the operation) of the processor 11, in particular, a fan rotation control program and data that is referred to when the program is executed. The RAM is a work memory used when the processing or operation of the processor 11 is executed, and temporarily stores data or information generated or acquired in the pieces of processing.

The memory 12 holds, for example, fan sound analysis data in advance. The fan sound analysis data may be acquired from an external device and at least temporarily held in the memory 12. The memory 12 may hold information on the rule for defining a simultaneous masking range and a temporal masking range to be described later.

The communication device 13 communicates with other terminals in the vehicle and in the fan control system 1, the microphone 20, the temperature sensor 30, and the fan 40 via the network in FIG. 1 to enable transmission and reception of data.

The microphone 20 collects the environmental sound in the vehicle. The microphone 20 is, for example, a microphone provided in the vehicle. The microphone 20 is, for example, a microphone mounted in the vehicle for hands-free or voice recognition.

The temperature sensor 30 measures the temperature of the cooling target. The temperature sensor 30 is, for example, a thermistor or a thermal diode. The temperature sensor 30 is not essential, and the temperature sensor 30 may not be provided. The temperature sensor 30 may be provided, for example, near the cooling target or inside the cooling target.

The fan 40 cools the cooling target by blowing air. The cooling target may be, for example, a semiconductor such as a central control device in the vehicle. The cooling target may be, for example, a system on a chip (SoC), an audio amplifier, a power supply device, or a device brought by a user such as a smartphone. The cooling target may be an object that easily generates heat other than the semiconductor. The fan 40 may be provided, for example, near or above the cooling target.

Next, an index related to the human audibility will be described.

First, an equal loudness level curve will be described.

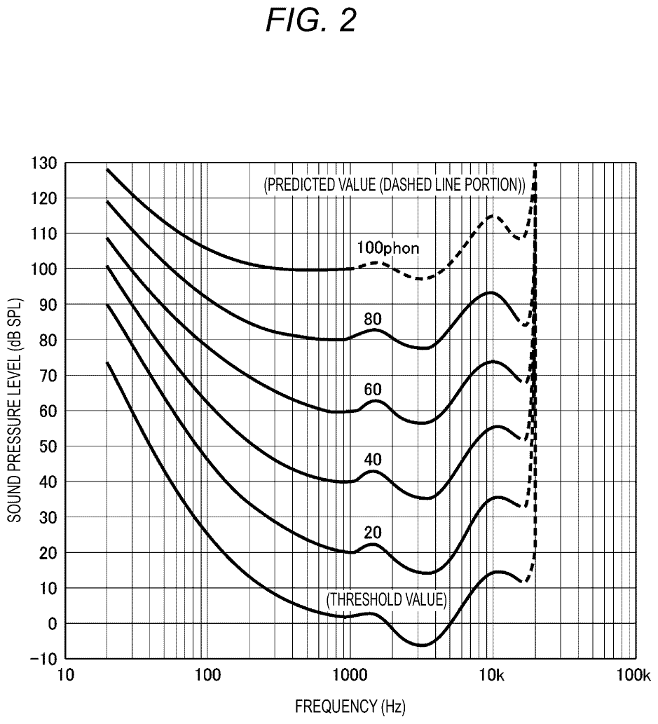

FIG. 2 is a diagram showing an example of the equal loudness level curve according to the present embodiment. In FIG. 2, the horizontal axis represents the frequency, and the vertical axis represents the sound pressure level. FIG. 2 shows the equal loudness level curve according to the ISO226:2003 standard.

The equal loudness level curve indicates the frequency characteristics obtained by connecting the sound pressure levels at which sounds of various frequencies are heard as having the same auditory volume, that is, the same loudness. That is, the equal loudness level curve can also be said to be an equal loudness curve indicating the basic frequency sensitivity characteristic of hearing, and is one of the most fundamental characteristics of the hearing. Auditory is also referred to as auditory sensation or auditory perception.

As shown in FIG. 2, even if the sound pressure level is the same, the sound pressure level may be perceived differently in the audibility of a person depending on the frequency of the sound. For example, with reference to FIG. 2, it can be said that a person is likely to perceive that “the sound is loud” even if the sound pressure level is high when the sound frequency is low, and a person is likely to perceive that “the sound is loud” even if the sound pressure level is low when the sound frequency is high. For example, when any value between 20 phon and 40 phon, for example, 30 phon is set as an audibility threshold value for auditorily perceiving that “the sound is loud” or “the sound is not loud”, it can be seen that the allowable sound pressure level changes depending on the frequency.

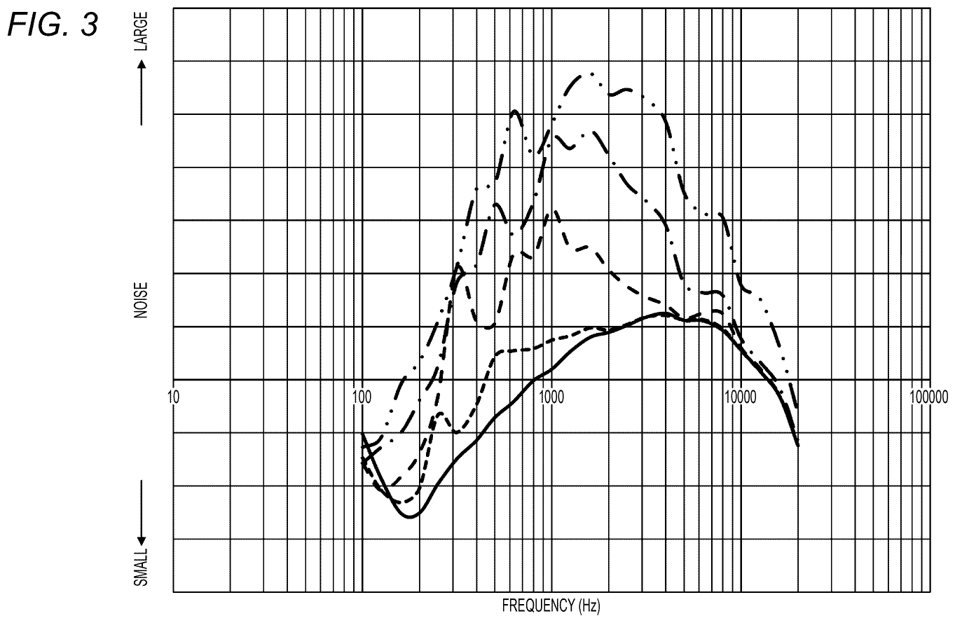

FIG. 3 is a diagram showing an example of the relationship among the rotation speed of the fan 40, the frequency of the fan sound, and the sound pressure level of the generated noise according to the present embodiment.

FIG. 3 shows the fan sound analysis data, that is, the sound pressure level for each frequency of the fan sound recorded in advance. In FIG. 3, the horizontal axis represents the frequency, and the vertical axis represents the sound pressure level of the fan sound. As shown in FIG. 3, as the rotation speed increases, the peak of the graph shown in FIG. 3 increases, and the sound pressure level increases.

For example, with reference to the equal loudness level curve in FIG. 2 and the fan sound analysis data in FIG. 3, the processor 11 determines whether “the sound is loud” auditorily or “the sound is not loud” auditorily in each frequency of the fan sound, and determines the upper limit of the rotation speed of the fan 40 according to the determination result. In this case, the processor 11 may determine the upper limit of the rotation speed of the fan 40 such that the sound pressure level of the fan sound analysis data is lower than the sound pressure level of the environmental sound analysis data in each frequency that affects the audibility. For example, the processor 11 may increase the upper limit of the rotation speed of the fan 40 as the sound pressure level of the sound component is higher and decrease the upper limit of the rotation speed of the fan 40 as the sound pressure level of the sound component is lower for the frequency of the sound component equal to or higher than the audibility threshold value among the sound components included in the environmental sound within a range not affecting the audibility. Accordingly, the fan control device 10 can cause the fan sound to be in a state that “the sound is not loud” auditorily while adjusting the amount of change in the rotation speed according to the loudness of the environmental sound in each frequency. Here, the environmental sound analysis data, that is, the sound pressure level of the environmental sound in a first frequency, which is a frequency that affects the audibility, is the first index. The first condition is that the sound pressure level of the fan sound at the frequency that affects the audibility is lower than the sound pressure level of the environmental sound in the first frequency.

Here, it is exemplified that the frequency that affects the audibility is extracted based on the equal loudness level curve and the fan sound analysis data, but the present disclosure is not limited thereto. The processor 11 may extract the frequency that affects the audibility based on the equal loudness level curve and the environmental sound analysis data.

Next, the auditory masking will be described. The auditory masking refers to the reduction in the perception of one sound by the presence of another sound. Examples of the auditory masking include simultaneous masking and temporal masking.

First, the simultaneous masking will be described.

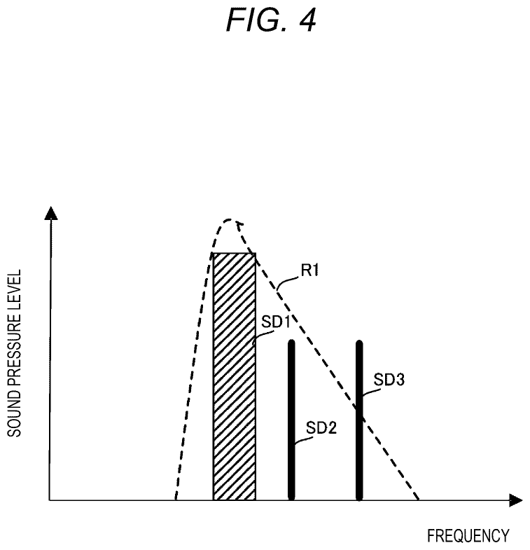

FIG. 4 is a diagram showing the simultaneous masking according to the present embodiment. In FIG. 4, the horizontal axis represents the frequency of the sound, and the vertical axis represents the sound pressure level of the sound.

The simultaneous masking occurs when the environmental sound and the fan sound are simultaneously generated. The simultaneous masking relates to the dynamic behavior of the basilar membrane of the cochlea. The simultaneous masking occurs when a membrane vibration generated by a sound normally detected in a quiet environment is covered by another sound, specifically, a vibration generated by a sound having a frequency sufficiently close to that of the first sound at a sufficient sound pressure level. The simultaneous masking is also referred to as spectral masking or frequency masking.

When an environmental sound SD1 as shown in FIG. 4 is generated, the sound falling within a simultaneous masking range R1 cannot be auditorily distinguished from the environmental sound SD1, in other words, the listener cannot hear the sound. The simultaneous masking range R1 is a range of the frequency and sound pressure level to be simultaneously masked with reference to the environmental sound SD1. On the other hand, a sound that does not fall within the simultaneous masking range R1 can be auditorily distinguished from the environmental sound SD1, in other words, can be heard by the listener. That is, the sound closer to the environmental sound SD1 in the frequency is more difficult for the listener to hear due to the effect of the simultaneous masking. The simultaneous masking range R1 has a larger region in the higher frequency than in the lower frequency with respect to the frequency of the environmental sound SD1. This is because the masking effect is higher on the high frequency side with respect to the environmental sound SD1.

The range of the simultaneous masking range R1 is an example of the range that does not affect the audibility. A set of combinations of the frequency and sound pressure level constituting the contour of the simultaneous masking range R1 is an example of the audibility threshold value. The shape and size of the simultaneous masking range R1 are examples, and may be other shapes and sizes because the shape and size depend on the frequency and sound pressure level of the environmental sound to be masked. The simultaneous masking range R1 indicates a range of the frequency and sound pressure level of the sound masked by the environmental sound according to the frequency and sound pressure level of the environmental sound. The simultaneous masking range R1 is an example of the first index. The fan sound falling within the simultaneous masking range R1 is an example of the first condition.

As a specific example, as shown in FIG. 4, it is assumed that a fan sound SD2 and a fan sound SD3 having different frequencies from the environmental sound SD1 are generated simultaneously with the environmental sound SD1. In this case, the fan sound SD2 falls within the simultaneous masking range R1 and is masked. The fan sound SD3 does not fall within the simultaneous masking range R1, and at least a part thereof is not masked. The masked fan sound SD2 does not affect the audibility. The fan sound SD3 that is not masked may affect the audibility.

The processor 11 determines the simultaneous masking range R1 based on the frequency and sound pressure level of the environmental sound SD1. In this case, for example, the memory 12 may hold in advance information on the rule related to generation of the simultaneous masking range according to the frequency and sound pressure level of the environmental sound SD1. The processor 11 may determine the simultaneous masking range R1 based on the information on the rule held in the memory 12.

The processor 11 may determine the upper limit of the rotation speed of the fan 40 based on the fan sound analysis data corresponding to the rotation speed shown in FIG. 3 and the simultaneous masking range R1. In this case, the processor 11 may determine the upper limit of the rotation speed such that the fan sound is included in the simultaneous masking range R1. That is, the processor 11 may determine the upper limit of the rotation speed such that the sound pressure level of the fan sound is equal to or lower than the maximum sound pressure level within the simultaneous masking range R1 in the frequency included in the simultaneous masking range R1.

In this way, the processor 11 may determine the simultaneous masking range R1 indicating the range of the frequency and sound pressure level at which the fan sound generated simultaneously with the generation of the environmental sound SD1 is masked, according to the frequency and sound pressure level of the environmental sound SD1. The processor 11 may determine the upper limit of the rotation speed of the fan 40 such that the fan sound is within the simultaneous masking range R1.

Next, the temporal masking will be described.

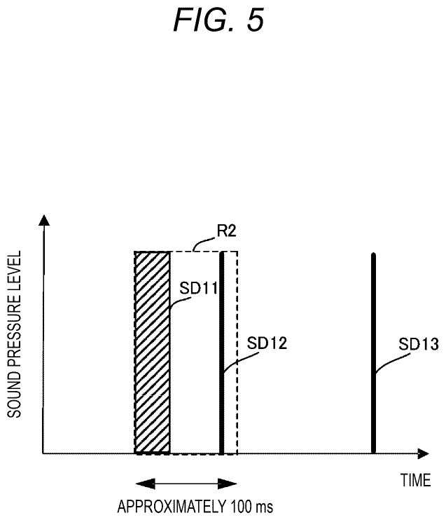

FIG. 5 is a diagram showing the temporal masking according to the present embodiment. In FIG. 5, the horizontal axis represents the time, and the vertical axis represents the sound pressure level of the sound.

The temporal masking occurs between temporally continuous sounds. As the temporal masking, the fan sound generated before and after the time when the environmental sound is generated may be masked. In the example shown in FIG. 5, masking of the fan sound generated after the time when the environmental sound is generated will be described. The temporal masking may occur when the time difference between the two sounds is 200 ms at the maximum. For example, the processor 11 may determine that masking is performed when the value of the time difference between the two sounds is equal to or less than a time threshold value, for example, 100 ms. The temporal masking does not depend on the frequency of the generated environmental sound.

When an environmental sound SD11 as shown in FIG. 5 is generated, the sound falling within a temporal masking range R2 cannot be auditorily distinguished from the environmental sound SD11, in other words, the listener cannot hear the sound. The temporal masking range R2 is a range of the time and sound pressure level to be temporally masked with reference to the environmental sound SD11. On the other hand, a sound that does not fall within the temporal masking range R2 can be auditorily distinguished from the environmental sound SD11, in other words, can be heard by the listener. That is, the sound closer to the environmental sound SD11 in the time of occurrence is more difficult for the listener to hear due to the effect of the temporal masking.

The range of the temporal masking range R2 is an example of the range that does not affect the audibility. A set of combinations of the time and sound pressure level constituting the contour of the temporal masking range R2 is an example of the audibility threshold value. The temporal masking range R2 has, for example, a rectangular shape. The maximum sound pressure level of the temporal masking range R2 is, for example, the same sound pressure level as that of the environmental sound SD11. The temporal masking range R2 indicates the range of the generation time and sound pressure level at which the sound generated after generation of the environmental sound is masked according to the generation time and sound pressure level of the environmental sound. The temporal masking range R2 is an example of the first index. The fan sound falling within the temporal masking range R2 is an example of the first condition.

As a specific example, as shown in FIG. 5, it is assumed that a fan sound SD12 and a fan sound SD13 having different frequencies from the environmental sound SD11 are generated simultaneously with the environmental sound SD11. In this case, the fan sound SD12 falls within the temporal masking range R2 and is masked. The fan sound SD13 does not fall within the temporal masking range R2, and at least a part thereof is not masked. The masked fan sound SD12 does not affect the audibility. The fan sound SD13 that is not masked may affect the audibility.

The processor 11 determines the temporal masking range R2 based on the generation time and sound pressure level of the environmental sound SD1. In this case, for example, the memory 12 may hold in advance information on the rule related to generation of the temporal masking range according to the generation time and sound pressure level of the environmental sound SD11. The processor 11 may determine the temporal masking range R2 based on the information on the rule held in the memory 12.

The processor 11 may determine the upper limit of the rotation speed based on the fan sound analysis data corresponding to the rotation speed shown in FIG. 3 and the temporal masking range R2. In this case, the processor 11 may determine the upper limit of the rotation speed such that the fan sound is included in the temporal masking range R2. That is, the processor 11 may determine the upper limit of the rotation speed such that the sound pressure level of the fan sound is equal to or lower than the maximum sound pressure level within the simultaneous masking range R1 in the frequency included in the temporal masking range R2.

In this way, the processor 11 may determine the temporal masking range R2 indicating the range of the generation time and sound pressure level at which the fan sound generated after generation of the environmental sound SD11 is masked according to the generation time and sound pressure level of the environmental sound SD11. The processor 11 may determine the upper limit of the rotation speed of the fan 40 such that the fan sound is within the temporal masking range R2.

Next, an operation example of the fan control device 10 will be described.

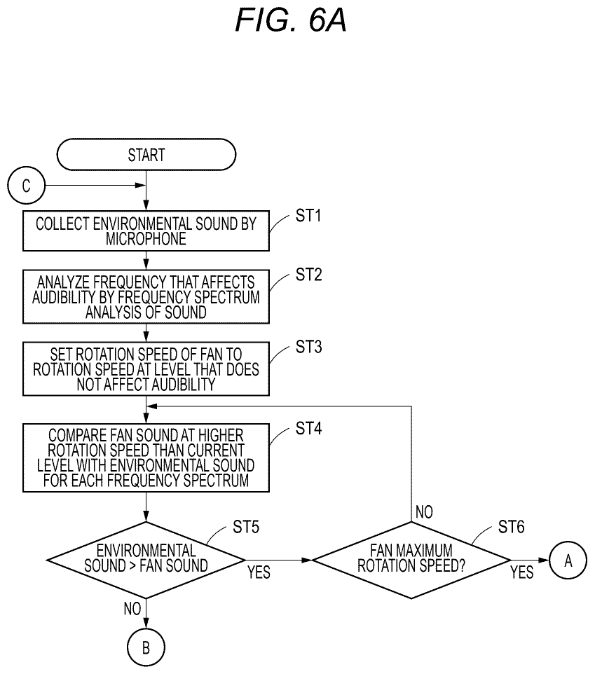

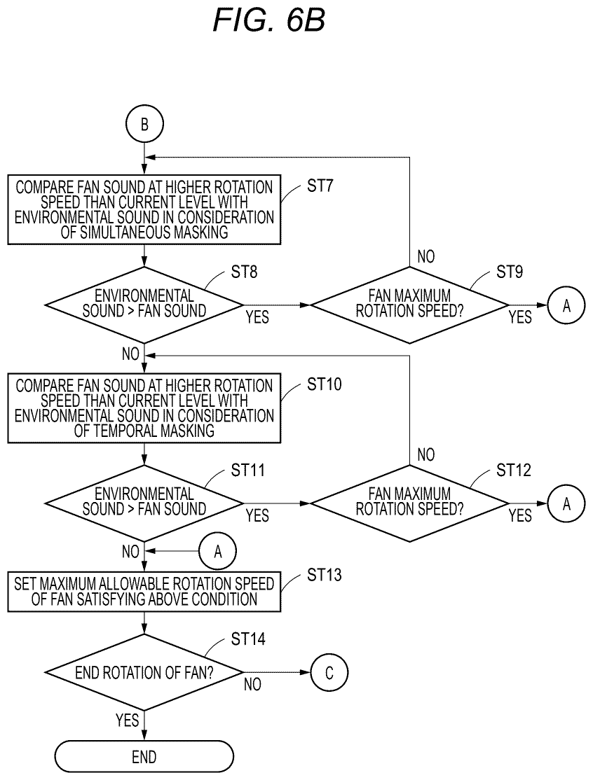

FIGS. 6A and 6B are flowcharts showing the operation example of the fan control device 10.

The fan control device 10 controls the fan 40 that cools a cooling target in the vehicle. The present operation example may be performed by changing the order of processing unless otherwise specified. The present operation example may be performed by the processor 11. Further, the present operation example may be performed by the processor 11 executing the fan control program stored in the memory 12.

The fan control device 10 may execute the processing in FIGS. 6A and 6B periodically, for example, every 20 ms. At this time, each time the processing in FIGS. 6A and 6B is executed, the processor 11 measures the processing time by, for example, a timer and derives the sound pressure level of the environmental sound. This processing time can also be said to be the generation time of the environmental sound generated during the processing in FIGS. 6A and 6B. The processor 11 holds information on the generation time and sound pressure level of the environmental sound in the memory 12. The generation time and sound pressure level of the environmental sound held in the memory may be used in the processing related to the temporal masking during processing after the processing in which the generation time and sound pressure level of the environmental sound are obtained.

First, in step ST1, the environmental sound in the vehicle is collected by the microphone 20 provided in the vehicle. The processor 11 acquires the environmental sound collected by the microphone 20.

In step ST2, the processor 11 analyzes the sound pressure level in each frequency by frequency spectrum analysis of the acquired environmental sound, and derives environmental sound analysis data. In step ST2, the processor 11 analyzes and extracts the frequency that affects the audibility in the equal loudness level curve among the frequencies of the environmental sound based on the environmental sound analysis data. The frequency that affects the audibility is a frequency at which the sensitivity of the audibility is higher than the audibility threshold value, and is, for example, a frequency at which the environmental sound exceeds 40 phon.

In step ST3, the processor 11 acquires fan sound analysis data from the memory 12, for example. The processor 11 sets the rotation speed of the fan 40 based on the environmental sound analysis data and the fan sound analysis data such that the sound pressure level does not affect the audibility for each frequency that affects the audibility.

The processor 11 may acquire the fan sound analysis data from the memory 12 in step ST2, and analyze and extract the frequency that affects the audibility in the equal loudness level curve among the frequencies of the fan sound based on the fan sound analysis data. In this case, in step ST3, the processor 11 may analyze the sound pressure level in each frequency by frequency spectrum analysis of the acquired environmental sound and derive the environmental sound analysis data. In this case, in step ST3, the processor 11 may also set the rotation speed of the fan 40 based on the environmental sound analysis data and the fan sound analysis data such that the sound pressure level does not affect the audibility for each frequency that affects the audibility.

In step ST4, the processor 11 assumes a rotation speed higher than the current rotation speed of the fan 40. The current rotation speed of the fan may be, for example, a command value of the rotation speed by the vehicle or the rotation speed detected by a rotation speed sensor (not shown). For example, when the current rotation speed of the fan 40 is 1000 rpm, the processor 11 assumes that the rotation speed is 2000 rpm or 3000 rpm. In step ST4, the processor 11 compares the fan sound analysis data for the assumed rotation speed with the environmental sound analysis data at the sound pressure level in each frequency.

The sound collection by the microphone 20 shown in step ST1, the frequency spectrum analysis shown in step ST2, the setting of the rotation speed of the fan 40 shown in step ST3, and the comparison between the fan sound and the environmental sound shown in step ST4 are performed within the temporal masking range R2, for example, within 20 ms.

In step ST5, as a result of the comparison, the processor 11 determines whether the sound pressure level of the frequencies of the environmental sound analysis data is higher than the sound pressure level of the frequencies of the fan sound analysis data for the assumed rotation speed.

In step ST6, when step ST5 is Yes, that is, when the sound pressure level of the environmental sound is higher than the sound pressure level of the fan sound in each frequency, the processor 11 determines whether the assumed rotation speed is the maximum rotation speed of the fan 40 (ST6).

When step ST6 is Yes, that is, when the assumed rotation speed is the maximum rotation speed of the fan 40, the processor 11 proceeds to step ST13.

When step ST6 is No, that is, when the assumed rotation speed is not the maximum rotation speed of the fan 40, the processor 11 proceeds to step ST4. Then, the processor 11 assumes a rotation speed higher than the currently assumed rotation speed as the rotation speed of the fan 40.

On the other hand, when step ST5 is No, that is, when the sound pressure level of the environmental sound is equal to or lower than the sound pressure level of the fan sound in at least one of the frequencies, the processor 11 proceeds to step ST7. That is, in at least one of the frequencies, when the sound pressure level of the frequencies of the environmental sound analysis data is equal to or less than the sound pressure level of the frequencies of the fan sound analysis data for the assumed rotation speed, the processor 11 proceeds to step ST7.

In step ST7, the processor 11 compares the fan sound, that is, the fan sound analysis data for the assumed rotation speed, that is, the rotation speed assumed in the last step ST4 with the environmental sound, that is, the environmental sound analysis data in consideration of the simultaneous masking. Specifically, the processor 11 determines the simultaneous masking range R1 based on the frequency and sound pressure level of the environmental sound included in the environmental sound analysis data. The processor 11 compares the maximum sound pressure level of each frequency inside the simultaneous masking range R1 with the sound pressure data of the same frequency in the fan sound analysis data for the assumed rotation speed.

In step ST8, as a result of the comparison, the processor 11 determines whether the maximum sound pressure level of each frequency within the simultaneous masking range R1 based on the environmental sound analysis data is larger than the sound pressure data of the same frequency in the fan sound analysis data for the assumed rotation speed.

In step ST9, when step ST8 is Yes, that is, when the sound pressure level of the environmental sound is higher than the sound pressure level of the fan sound in each frequency in consideration of the simultaneous masking, the processor 11 determines whether the assumed rotation speed is the maximum rotation speed of the fan 40. That is, when the maximum sound pressure level of each frequency within the simultaneous masking range R1 based on the environmental sound analysis data is larger than the sound pressure data of the same frequency in the fan sound analysis data for the assumed rotation speed, the processor 11 determines whether the assumed rotation speed is the maximum rotation speed of the fan 40.

When step ST9 is Yes, that is, when the assumed rotation speed is the maximum rotation speed of the fan 40, the processing proceeds to step ST13.

When step ST9 is No, that is, when the assumed rotation speed is not the maximum rotation speed of the fan 40, the processing proceeds to step ST7. Then, the processor 11 assumes a rotation speed higher than the currently assumed rotation speed as the rotation speed of the fan 40.

On the other hand, when step ST8 is No, that is, when the sound pressure level of the environmental sound is equal to or lower than the sound pressure level of the fan sound in at least one of the frequencies in consideration of the simultaneous masking, the processor 11 proceeds to step ST10. That is, when the maximum sound pressure level of at least one of the frequencies within the simultaneous masking range R1 based on the environmental sound analysis data is equal to or less than the sound pressure data of the same frequency in the fan sound analysis data for the assumed rotation speed, the processor 11 proceeds to step ST10.

In step ST10, the processor 11 compares the fan sound, that is, the fan sound analysis data for the assumed rotation speed, that is, the rotation speed assumed in the last step ST7 with the environmental sound, that is, the environmental sound analysis data in consideration of the temporal masking. Specifically, the processor 11 determines the temporal masking range R2 based on the generation time and sound pressure level of the environmental sound included in the environmental sound analysis data. In this case, the temporal masking range R2 used during the current execution of the processing in FIGS. 6A and 6B is determined based on the generation time and sound pressure level of the environmental sound held in the memory 12 during the previous execution of the processing in FIGS. 6A and 6B. Then, when the current time point, that is, the current processing time point in FIGS. 6A and 6B is a time point within the temporal masking range R2, the processor 11 compares the maximum sound pressure level within the temporal masking range R2 with the maximum sound pressure level among the sound pressure levels of the frequencies of the fan sound analysis data for the assumed rotation speed.

In step ST11, as a result of the comparison, when the current time point is a time point within the temporal masking range R2, the processor 11 determines whether the maximum sound pressure level within the temporal masking range R2 is higher than the maximum sound pressure level among the sound pressure levels of the frequencies of the fan sound analysis data for the assumed rotation speed.

In step ST12, when step ST11 is Yes, that is, when the sound pressure level of the environmental sound is higher than the sound pressure level of the fan sound in consideration of the temporal masking, the processor 11 determines whether the assumed rotation speed is the maximum rotation speed of the fan 40. That is, in a case in which the current time point is a time point within the temporal masking range R2, when the maximum sound pressure level within the temporal masking range R2 is higher than the maximum sound pressure level among the sound pressure levels of the frequencies of the fan sound analysis data for the assumed rotation speed, the processor 11 determines whether the assumed rotation speed is the maximum rotation speed of the fan 40.

When step ST12 is Yes, that is, when the assumed rotation speed is the maximum rotation speed of the fan 40, the processing proceeds to step ST13.

When step ST12 is No, that is, when the assumed rotation speed is not the maximum rotation speed of the fan 40, the processing proceeds to step ST10. Then, the processor 11 assumes a rotation speed higher than the currently assumed rotation speed as the rotation speed of the fan 40.

On the other hand, when step ST11 is No, that is, when the sound pressure level of the environmental sound is equal to or lower than the sound pressure level of the fan sound in consideration of the temporal masking, the processor 11 proceeds to step ST13. That is, in a case in which the current time point is a time point within the temporal masking range R2, when the maximum sound pressure level within the temporal masking range R2 is equal to or lower than the maximum sound pressure level among the sound pressure levels of the frequencies of the fan sound analysis data for the assumed rotation speed, the processor 11 proceeds to step ST13.

In step ST13, the processor 11 determines and sets the rotation speed assumed at this time point as the maximum allowable rotation speed, that is, the upper limit of the rotation speed of the fan 40. When the rotation speed of the fan 40 at this time is equal to or higher than the maximum allowable rotation speed, the processor 11 changes the rotation speed of the fan 40 to be equal to the maximum allowable rotation speed.

In step ST14, it is determined whether the rotation of the fan 40 ends. For example, when the rotation period of the fan 40 ends or when the end of the rotation of the fan 40 is instructed, it is determined that the rotation of the fan 40 ends.

When step ST14 is Yes, that is, when the rotation of the fan 40 ends, the processor 11 ends the processing in FIGS. 6A and 6B. On the other hand, when step ST14 is No, that is, when the rotation of the fan 40 is not ended, the processor 11 proceeds to step ST1 and executes the processing in FIGS. 6A and 6B again.

In this way, in steps ST4 to ST6, the fan control device 10 repeats the comparison between the environmental sound and the fan sound according to the rotation speed without considering the auditory masking and the assumption of the rotation speed until the sound pressure of the environmental sound exceeds the sound pressure of the fan sound in consideration of the audibility. In steps ST7 to ST9, the fan control device 10 repeats the comparison between the environmental sound and the fan sound according to the rotation speed in consideration of the simultaneous masking and the assumption of the rotation speed until the sound pressure of the environmental sound exceeds the sound pressure of the fan sound in consideration of the audibility. In steps ST10 to ST12, the fan control device 10 repeats the comparison between the environmental sound and the fan sound according to the rotation speed in consideration of the temporal masking and the assumption of the rotation speed until the sound pressure of the environmental sound exceeds the sound pressure of the fan sound in consideration of the audibility. It is not essential to perform all of these three series of processing, but it is sufficient to perform at least one series of processing. By performing all of the series of processing, the fan control device 10 can further improve the accuracy of determining the upper limit of the rotation speed.

The fan control device 10 may execute the processing in FIGS. 6A and 6B periodically, for example, every 20 ms. Accordingly, the fan control device 10 can suitably determine the upper limit of the rotation speed even when the environmental sound in the vehicle changes. The fan control device 10 can execute processing in consideration of the temporal masking assuming a time point different from the processing time point in FIGS. 6A and 6B.

In this way, according to the fan control device 10 in the present embodiment, the fan sound and the environmental sound are analyzed in consideration of the human audibility, it is auditorily determined whether the fan sound is equal to or less than the environmental sound, and the upper limit of the rotation speed of the fan 40 is controlled. The fan control device 10 can increase the rotation speed of the fan 40 within a range in which the fan sound is not larger than the environmental sound in consideration of various situations that do not affect the audibility. The fan control device 10 brings the upper limit of the rotation speed close to the physical maximum rotation speed of the fan 40 within a range that does not affect the audibility. For example, when the environmental sound is large, the fan control device 10 can further increase the rotation speed and improve the cooling performance of the fan 40.

Even when the environmental sound changes, the fan control device 10 can quickly lower the upper limit of the rotation speed of the fan 40 by periodically performing the flow in FIGS. 6A and 6B. As a result, the fan control device 10 can quickly reduce the actual rotation speed of the fan 40.

The processor 11 controls the fan sound to be smaller than the environmental sound in a human audible range, for example, 20 Hz to 20 kHz, but is not limited thereto outside the audible range. The processor 11 may control the fan sound to be slightly larger than the environmental sound outside the audible range.

Although various embodiments have been described above with reference to the drawings, it is needless to say that the present disclosure is not limited to such examples. It is apparent that those skilled in the art can conceive of various modifications or alterations within the scope described in the claims, and it is understood that such modifications and alterations naturally fall within the technical scope of the present disclosure. In addition, the constituent elements in the above embodiments may be freely combined without departing from the scope of the invention.

### APPENDIX

The following techniques are disclosed based on the above description of the embodiments.

### Technique 1

A fan control device including a processor and for controlling a fan configured to cool a cooling target in a vehicle, in which the processor is configured to:
acquire an environmental sound in the vehicle collected by a microphone provided in the vehicle;
derive first analysis data by executing frequency analysis on the acquired environmental sound;
acquire second analysis data obtained by executing frequency analysis on a fan sound that varies depending on a rotation speed of the fan and that is a sound generated during rotation of the fan; and determine an upper limit of the rotation speed of the fan based on the first analysis data and the second analysis data such that a first index of the environmental sound satisfies a predetermined first condition, the first index being an index related to audibility.

The processor is, for example, the processor 11. The fan is, for example, the fan 40. The fan control device is, for example, the fan control device 10. The microphone is, for example, the microphone 20. The first analysis data is, for example, the environmental sound analysis data. The second analysis data is, for example, the fan sound analysis data. The first threshold value is, for example, the audibility threshold value.

Accordingly, the fan control device can control the rotation speed of the fan such that a person present in the vehicle is less likely to perceive the noise as auditory noise, and can cool the cooling target.

### Technique 2

The fan control device according to (Technique 1),
in which the processor increases the upper limit of the rotation speed as a sound pressure level of the environmental sound increases, and decreases the upper limit of the rotation speed as the sound pressure level of the environmental sound decreases.

Accordingly, the fan control device can set the rotation speed to be high when the environmental sound is large, and can improve the cooling performance. The fan control device can set the rotation speed to be low when the environmental sound is small, and can prevent a person present in the vehicle from perceiving the noise.

### Technique 3

The fan control device according to (Technique 1) or (Technique 2),
in which the processor is configured to extract a first frequency that is a frequency in which the fan sound is larger than a first threshold value based on an equal loudness curve indicating a frequency sensitivity characteristic of hearing and the second analysis data, and
in which a sound pressure level of the fan sound in the first frequency is lower than the sound pressure level of the environmental sound in the first frequency based on the first analysis data and the second analysis data.

The equal loudness curve is, for example, the equal loudness level curve.

Accordingly, the fan control device specifies a frequency in which a person perceives that the sound is loud in the fan sound, and sets the sound pressure level of the fan sound to be lower than the sound pressure level of the environmental sound in this frequency, so that the person can be prevented from perceiving that the fan sound is noise.

### Technique 4

The fan control device according to (Technique 1) or (Technique 2),
in which the processor is configured to extract a first frequency that is a frequency in which the environmental sound is larger than a first threshold value based on an equal loudness curve indicating a frequency sensitivity characteristic of hearing and the first analysis data,
in which the first index is a sound pressure level of the environmental sound in the first frequency, and
in which the first condition is that a sound pressure level of the fan sound in the first frequency is lower than the sound pressure level of the environmental sound in the first frequency.

Accordingly, the fan control device specifies a frequency in which a person perceives that the sound is loud in the environmental sound, and sets the sound pressure level of the fan sound to be lower than the sound pressure level of the environmental sound in this frequency, so that the person can be prevented from perceiving that the fan sound is noise.

### Technique 5

The fan control device according to any one of (Technique 1) to (Technique 4),
in which the processor is configured to determine, as the first index, a first masking range indicating a range of a frequency and a sound pressure level of a sound masked by the environmental sound according to acquired frequency and sound pressure level of the environmental sound, and
in which the first condition is that the fan sound is within the first masking range.

The first masking range is, for example, the simultaneous masking range R1.

Accordingly, the fan control device can control the rotation speed of the fan within a range that does not affect the audibility, taking into account the simultaneous masking.

### Technique 6

The fan control device according to any one of (Technique 1) to (Technique 5),
in which the processor is configured to determine, as the first index, a second masking range indicating a range of a generation time and a sound pressure level at which a sound generated after generation of the environmental sound is masked according to acquired generation time and sound pressure level of the environmental sound, and
in which the first condition is that the fan sound is within the second masking range.

The second masking range is, for example, the temporal masking range R2.

Accordingly, the fan control device can control the rotation speed of the fan within a range that does not affect the audibility, taking into account the temporal masking.

### Technique 7

The fan control device according to any one of (Technique 1) to (Technique 6),
in which the processor is configured to:
   acquire information on a temperature of the cooling target, and
   increase the upper limit of the rotation speed of the fan when the temperature is equal to or higher than a second threshold value.

The second threshold value is, for example, the temperature threshold value.

Accordingly, the fan control device can increase the rotation speed of the fan, for example, only when the temperature of the cooling target is high. Therefore, the fan control device can ensure necessary cooling performance while reducing the processing load of the fan control device.

### Technique 8

A fan control method for controlling a fan configured to cool a cooling target in a vehicle, the fan control method including:
acquiring an environmental sound in the vehicle collected by a microphone provided in the vehicle;
deriving first analysis data by executing frequency analysis on the acquired environmental sound;
acquiring second analysis data obtained by executing frequency analysis on a fan sound that varies depending on a rotation speed of the fan and that is a sound generated during rotation of the fan; and
determining an upper limit of the rotation speed of the fan based on the first analysis data and the second analysis data such that an index related to audibility falls within a range of a first threshold value.

Accordingly, the fan control method can attain the same effects as those of Technique 1.

### Technique 9

A fan control program for causing a computer to execute the fan control method according to Technique 6.

Accordingly, the fan control program can attain the same effects as those of Technique 1.

### INDUSTRIAL APPLICABILITY

The present disclosure is useful as a fan control device, a fan control method, a fan control program, and the like capable of controlling the rotation speed of a fan such that a person present in a vehicle is less likely to perceive the noise as auditory noise.

What is claimed is:

1. A fan control device that controls a fan used for cooling a cooling target in a vehicle, the fan control device comprising:
a memory storing instructions; and
a processor that implements the instructions to
acquire an environmental sound in the vehicle collected by a microphone provided in the vehicle;
derive first analysis data by executing frequency analysis on the acquired environmental sound;
acquire second analysis data obtained by executing frequency analysis on a fan sound that varies depending on a rotation speed of the fan and that is a sound generated during rotation of the fan; and
determine an upper limit of the rotation speed of the fan based on the first analysis data and the second analysis data such that a first index of the environmental sound satisfies a predetermined first condition, the first index being an index related to audibility.

2. The fan control device according to claim 1, wherein
the processor implements the instructions to
increase the upper limit of the rotation speed as a sound pressure level of the environmental sound increases, and
decrease the upper limit of the rotation speed as the sound pressure level of the environmental sound decreases.

3. The fan control device according to claim 1, wherein
the processor implements the instructions to extract a first frequency that is a frequency in which the fan sound is larger than a first threshold value based on an equal loudness curve indicating a frequency sensitivity characteristic of hearing and the second analysis data,
the first index is a sound pressure level of the environmental sound in the first frequency, and
the first condition is that a sound pressure level of the fan sound in the first frequency is lower than the sound pressure level of the environmental sound in the first frequency.

4. The fan control device according to claim 1, wherein
the processor implements the instructions to extract a first frequency that is a frequency in which the environmental sound is larger than a first threshold value based on an equal loudness curve indicating a frequency sensitivity characteristic of hearing and the first analysis data,
the first index is a sound pressure level of the environmental sound in the first frequency, and
the first condition is that a sound pressure level of the fan sound in the first frequency is lower than the sound pressure level of the environmental sound in the first frequency.

5. The fan control device according to claim 1, wherein
the processor implements the instructions to determine, as the first index, a first masking range indicating a range of a frequency and a sound pressure level of a sound masked by the environmental sound according to acquired frequency and sound pressure level of the environmental sound, and
the first condition is that the fan sound is within the first masking range.

6. The fan control device according to claim 1, wherein
the processor implements the instructions to determine, as the first index, a second masking range indicating a range of a generation time and a sound pressure level at which a sound generated after generation of the environmental sound is masked according to acquired generation time and sound pressure level of the environmental sound, and
the first condition is that the fan sound is within the second masking range.

7. The fan control device according to claim 1, wherein
the processor implements the instructions to
acquire information on a temperature of the cooling target, and
increase the upper limit of the rotation speed of the fan when the temperature is equal to or higher than a second threshold value.

8. The fan control device according to claim 1, wherein
the processor implements the instructions to
acquire information on a temperature of a cooling target, and
maintain or reduce the upper limit of the rotation speed of the fan when the temperature of the cooling target is less than a predetermined temperature threshold value.

9. The fan control device according to claim 1, wherein
the first analysis data is frequency spectrum data related to the environmental sound data, and
the second analysis data is frequency spectrum data related to the fan sound.

10. The fan control device according to claim 5, wherein
the processor implements the instructions to
determine an upper limit of the rotation speed of the fan based on the second analysis data and the first masking range such that the fan sound is included in the first masking range.

11. The fan control device according to claim 6, wherein
the processor implements the instructions to
determine an upper limit of the rotation speed of the fan based on the second analysis data and the second masking range such that the fan sound is included in the second masking range.

12. A fan control method that controls a fan used for cooling a cooling target in a vehicle, the fan control method comprising:
acquiring an environmental sound in the vehicle collected by a microphone provided in the vehicle;
deriving first analysis data by executing frequency analysis on the acquired environmental sound;
acquiring second analysis data obtained by executing frequency analysis on a fan sound that varies depending on a rotation speed of the fan and that is a sound generated during rotation of the fan; and
determining an upper limit of the rotation speed of the fan based on the first analysis data and the second analysis data such that a first index of the environmental sound satisfies a predetermined first condition, the first index being an index related to audibility.

13. A computer readable storage medium on a fan control program for causing a computer to execute the fan control method according to claim 12 is stored.
